(19) United States
(12) Patent Application Publication
(10) Pub. No.: US 2014/0087354 A1
(43) Pub. Date: Mar. 27, 2014

(54) Systems and Methods for Evaluating Technical Articles

(71) Applicants: Keith Collier, Crozet, VA (US); Laura Stemmle, Durham, NC (US); Jeffrey Grigston, Chapel Hill, NC (US)

(72) Inventors: Keith Collier, Crozet, VA (US); Laura Stemmle, Durham, NC (US); Jeffrey Grigston, Chapel Hill, NC (US)

(21) Appl. No.: 13/665,304

(22) Filed: Oct. 31, 2012

Related U.S. Application Data
(63) Continuation of application No. 13/627,806, filed on Sep. 26, 2012.

(51) Int. Cl. G09B 7/00

(52) U.S. Cl. 434/353

(57) ABSTRACT

The system includes an evaluation server configured to receive an article from an author. The article is then distributed to one or more reviewers who are technically qualified to evaluate the article. Further, the reviewers are provided with a scorecard that provides for specific aspects to be evaluated. Each reviewer completes his or her evaluation and submits his or her scores to the evaluation server. The evaluation server compiles the scores from each of the reviewers and calculates an aggregate score for the article. The server may be further configured to match the submitted articles with various technical journals that may be interested in the article. The server may give journals the ability to monitor articles that come through the process and that match a set of journal-definable requirements. The system may also provide authors with a list of matching journals.

### CROSS-REFERENCE TO RELATED APPLICATION

This is a continuation of application Ser. No. 13/627,806 filed on Sep. 26, 2012, entitled “Systems and Methods for Evaluating Technical Articles” which is hereby incorporated by reference in its entirety.

### FIELD OF THE INVENTION

The present application is directed to systems and methods of evaluating a technical article and, more particularly, to providing standardization and structure to the peer review process for a technical article and for matching articles to applicable journals.

### BACKGROUND

Technical articles are written by authors in a wide range of fields. The authors may be students, members of the academic community teaching or conducting research within a particular technical field, business professionals working with the technical field, or others that have an interest in the technical field. The articles are submitted to one or more technical journals related to the technical field. The editors of the journals review the articles and publish those that meet some criteria set by the particular journal.

A drawback of the current process for the authors is the credibility within the technical community that is credited to the technical article. Often times a large degree of the credibility is based on the particular journal that publishes the article. For example, an article may gain a large amount of credibility if it were to be published in a prestigious or high impact journal while the same article would gain a much smaller amount of credibility if published in a less prestigious or lower impact journal. As such, there is a need for a system and methods of evaluating a technical article based on the merits of the article itself, and not the journal in which it is published.

The current process also has drawbacks for editors of the technical journals. The editors usually require that the article be reviewed by one or more qualified reviewers prior to publishing the article. This requirement may cause a burden on the journal editors, who often work within a narrow time window in which to receive an article, obtain a competent review, and then publish the article within their journal.

Another drawback for both authors and journal editors is the ability of the author to select the appropriate journal for a given article. This is an inefficient process where authors may only submit his or her articles to one journal at a time. If rejected for publication, the author then has to submit to another journal. Likewise, journals are often searching for new technical articles that fit within their needs for an upcoming journal issue. Journals currently have little or no mechanism for attracting specific articles that meet their needs.

Therefore, there exists a need for systems and methods of providing a standardized review process for technical articles and of matching particular articles with applicable journals.

### SUMMARY

The present application is directed to systems and methods of providing independent peer review and journal matching for technical articles. The systems and methods may operate independently of individual journals, and provide authors with a standardized score for his or her research based on a peer review by qualified reviewers. Journals will be able to use the systems and methods to find new research that fits their needs prior to submission to their own peer review or editorial decision process.

One aspect is directed to methods of evaluating a technical article that is submitted by an author and the method is implemented by a server. The article and an evaluation interface are provided to a plurality of reviewers. The evaluation interface is divided into a number of different sections and sub-sections, and includes a number of criteria. The reviewers provide input through the evaluation interface indicating which of the criteria are applicable to the article. Based on the received criteria, a score may be determined for each of the reviewers. The server calculates an aggregate score for the article, and may also calculate scores for one or more of the sections or sub-sections. A report is generated for the article that includes at least the aggregate score for the article.

Another aspect is directed to methods of matching technical articles to prospective journals and is implemented by a server. The server receives requests through a first interface from a number of different journals. The journals are interested in articles that meet certain requirements that are included in the request, such as for articles in specific technical fields and articles that have a minimum aggregate score. The server also receives through a second interface technical articles from a variety of authors. The articles are classified into technical fields and are evaluated by two or more reviewers. The server calculates an aggregate score for each of the articles based on the evaluations from the reviewers. The server provides to the journals, through the first interface, a listing of the articles, and may flag the articles that meet the journal's requirements. The server may provide to each of the authors, through the second interface, a listing of the journals for which his or her article satisfies the journal's requirements.

One embodiment is directed to a method of evaluating a technical article having an assigned technical field, with the method being implemented by an evaluation server. The method includes providing to each of a plurality of reviewers a technical article and an evaluation interface including a first set of predefined grading criteria for determining an expected impact of the article within the technical field, and a separate second set of predefined grading criteria for determining a technical competency of the technical article. The grading from the reviewers is received through the evaluation interface. The method further includes calculating an aggregate expected impact score for the article based on the received criteria selections for the first set of grading criteria from each of the plurality of reviewers. The method includes obtaining through a predefined mapping function, a multiplier based on the aggregate expected impact score, and calculating an aggregate technical competency score based on the received criteria selections for the second set of grading criteria from each of the plurality of reviewers. The method includes calculating an aggregate score for the article as a function of the aggregate technical competency score and the multiplier, and generating a report for the article that includes at least the aggregate score for the article.

The step of calculating the aggregate expected impact score based on the received criteria selections for the first set of grading criteria from each of the plurality of reviewers may include determining a numerical value for each of the criteria selections from each of the reviewers and averaging the numerical values. The step of calculating the aggregate technical competency score based on the received criteria selections for the second set of grading criteria from each of the plurality of reviewers may include determining a numerical value for each of the received criteria selections from each of the reviewers and averaging the numerical values. The method may include accessing a look-up table maintained at the evaluation server and determining the multiplier based on the aggregate expected impact score. The multiplier may be a numerical number between 0.50 and 1.0. Further, the multiplier is less than or equal to one. The method may include calculating an aggregate quality of research score and an aggregate quality of presentation score based on the received criteria selections for the second set of grading criteria from each of the reviewers. The method may also include sending the report to a journal that publishes information within the technical field. The method may also include dynamically providing, through the evaluation interface, visual indicators to the reviewers corresponding to the received criteria selections.

Another embodiment is directed to a method of evaluating a technical article and is implemented by an evaluation server. The method includes providing a plurality of reviewers with a technical article that is applicable to a particular technical field and an evaluation interface for evaluating the technical article. The evaluation interface includes a plurality of predefined evaluation components that each include one or more sub-components, and one or more predefined grading criteria for each of the one or more sub-components. The method includes for each reviewer, receiving through the evaluation server, the grading criteria selected by the reviewer. The method includes for each reviewer, dynamically providing through the evaluation interface visual indicators indicating a score for each of the sub-components, the scores corresponding to the received criteria selections. The method includes for each reviewer, receiving through the evaluation server an input for adjusting at least one of the sub-component scores without changing the grading criteria selected by the reviewer. The method includes calculating a reviewer score for each reviewer based on the grading criteria selected by the reviewer and the input for adjusting at least one of the sub-component scores. The method further includes calculating an aggregate score for each of the evaluation components based on the corresponding scores from each of the reviewers, calculating an aggregate score for the technical article based on the aggregate scores for each of the evaluation components, and generating a report for the technical article that includes at least the aggregate score for the technical article.

In this method, the plurality of evaluation components may include a technical competency component and an expected impact component. The method may also include calculating at least one sub-component score for each of the reviewers by accessing a look-up table. The method may also include sending the report to a journal that publishes information within the technical field. The step of calculating the aggregate score for each of the evaluation components based on the corresponding scores from each of the reviewers may include averaging the corresponding scores, or may include weighting the corresponding score from at least one of the reviewers a greater amount than another one of the reviewers.

The application also discloses a method of matching technical articles to prospective journals with the method being implemented by a server. The method includes receiving a request through a first request interface from each of a plurality of journals that each publishes information within one or more technical areas. The requests each include requirements for a desired technical field and a minimum aggregate score. The method includes receiving a plurality of technical articles from authors through a second evaluation interface, with each of the technical articles being classified in a particular technical field. The method includes storing each of the technical articles, and evaluating each of the articles using at least two independent reviewers and calculating an aggregate score for the article. The method includes generating a report for each of the articles that includes at least the aggregate score. The method also includes mapping each of the articles with the corresponding aggregate score and the technical field, indicating to each of the journals, through the first request interface, the evaluated articles and flagging the articles with the aggregate score meeting the minimum aggregate score and being classified in the desired technical field, and providing to each of the authors, through the second evaluation interface, a listing of the journals in which their article satisfies the journal requirements.

The various aspects of the embodiments may be used alone or in any combination, as is desired.

### BRIEF DESCRIPTION OF THE DRAWINGS

FIG. 1 is a schematic diagram of a data communication network.

FIG. 2 is a schematic diagram of an evaluation server and associated database.

FIG. 3 is a flowchart illustrating the steps for authorizing a reviewer within one or more technical fields.

FIG. 4 is a flowchart illustrating the steps of receiving an article at the server from an author.

FIG. 5 is a scorecard for evaluating an article.

FIG. 6 is a portion of a scorecard illustrating scores for three separate sub-components.

FIG. 7 is a flowchart illustrating the steps of the evaluation process performed by a reviewer.

FIG. 8 is a table indicating the aggregate scoring for the expected impact for an article.

FIG. 9 is a table indicating an aggregate expected impact score and corresponding multiplier.

FIG. 10 is a flowchart illustrating scoring of an article by the server.

FIG. 11 is a flowchart illustrating a process of establishing an account with a journal.

FIG. 12 is a flowchart illustrating a process of providing articles to a journal.

FIG. 13 is a flowchart illustrating a process of providing a listing or relevant journals to an author.

### DETAILED DESCRIPTION

The present application is directed to methods and systems for evaluating technical articles and for matching the articles with one or more technical journals. The system includes an evaluation server configured to receive an article from an author. The article is then distributed to one or more reviewers who are technically qualified to evaluate the article. Further, the reviewers are provided with a scorecard that provides for specific aspects to be evaluated, such as the expected impact of the article within the technical community and the technical competency of the article. Each reviewer completes his or her evaluation and submits his or her scores to the evaluation server. The evaluation server compiles the scores from each of the reviewers and calculates an aggregate score for the article. The server may further process an evaluation report that is accessible to the author.

The server is further configured to match the submitted articles with various technical journals that may be interested in the article. The server may either determine by analysis or via input from the author or an outside user one or more technical aspects covered in the article. The server further may include a database of technical journals and subject areas in which they have an interest. The system may give journals the ability to monitor articles that come through the process and that match a set of journal-definable requirements. The system may also provide authors with a list of matching journals based on his or her article's content and scores.

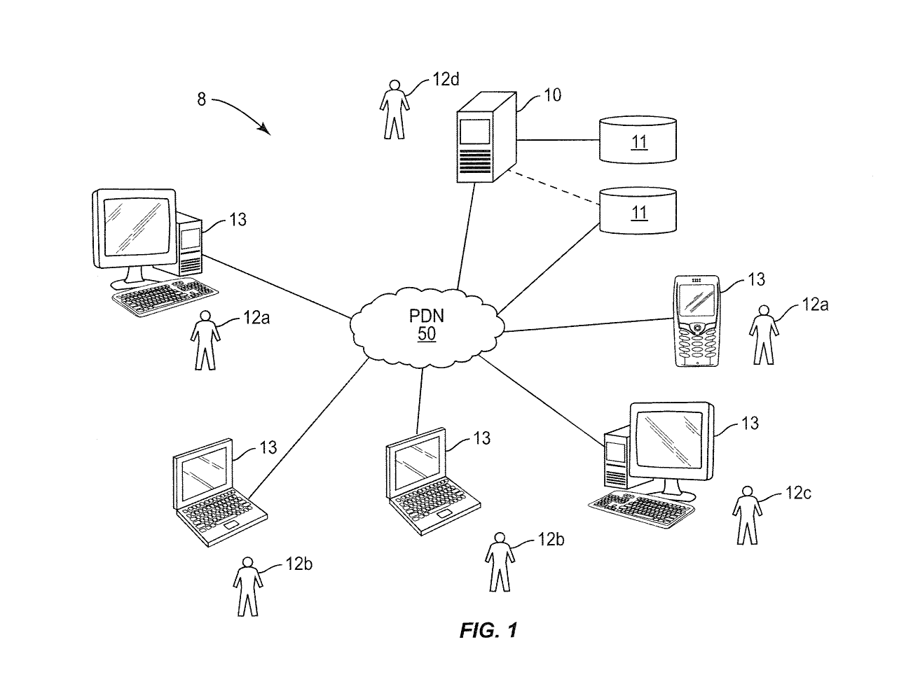

In one embodiment, the system is configured for browser-based accessibility with communications through one or more networks. FIG. 1 illustrates one embodiment of a data communication network 8 that provides networking capabilities for a plurality of entities that participate in the functionality disclosed in the present application. The data communication network 8 includes a Packet Data Network (PDN) 50. PDN 50 comprises a packet-switched network that implements conventional protocols, such as the suite of Internet protocols. The PDN 50 may comprise a public or private network, and may include one or more wide area or local area networks. One example of a PDN 50 is the Internet. The browser-based interface may include well-known browsers such as Internet Explorer and Mozilla Firefox, or may also include specific applications to communicate with the server 10 over the PDN 50.

Different entities 12 including authors 12a, reviewers 12b, and technical journal administrators 12c may participate through various devices 13, such as laptop computers, personal computers, personal digital assistants, mobile computing/communication, tablet devices, and various other like computing devices. Each of these entities 12 uses a device 13 and accesses the server 10 through the PDN 50, or alternatively some other network. In one embodiment, one or more of the entities 12 may use his or her respective device 13 to access the server 10 through a separate portal. Each entity's portal may include a secure interface through which the entity may access the information that is assigned to them.

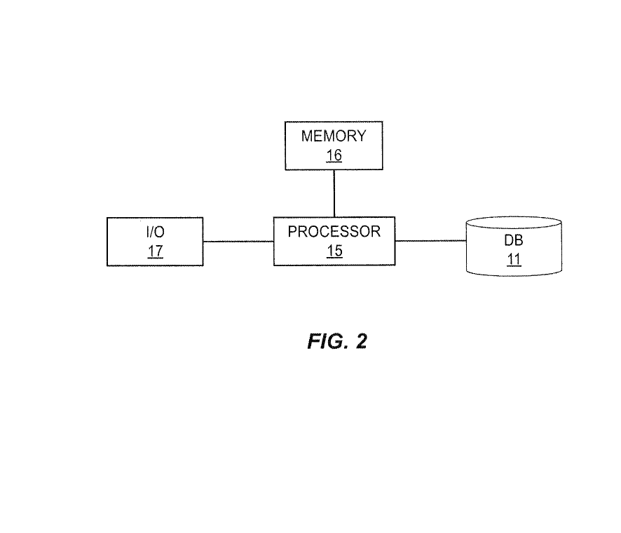

The evaluation server 10 is accessible via the PDN 50 to each of the devices 13. The evaluation server 10 may be configured as illustrated in FIG. 2. The server 10 includes a processor 15 that may include one or more microprocessors, microcontrollers, hardware circuits, and/or a combination thereof. Memory 16 stores data and programs needed by the processor 15. Memory 16 may include various memory devices such as random access memory, read-only memory, and flash memory. An I/O interface 17 connects the server 10 to the PDN 50 and may include an Ethernet interface, cable modem, or DSL interface. The database 11 may be stored in a magnetic or optical disk drive. The database 11 may be local or remote relative to the server 10.

The system is configured for accessing information through the server 10 using a browser-based interface. The browser-based interface may include a website through which the contents of the database 11 may be accessible. Although the website may be hosted by the server 10, it may also be hosted at another location accessible through the PDN 50. The different entities 12 may log into and access the pertinent information at various stages throughout the process. The entities 12 that access and contribute to the system include authors 12a that submit technical articles, reviewers 12b that evaluate the technical articles, and technical journal administrators 12c that operate journals interested in publishing the articles. The server 10 may further be administered by one or more administrators 12d.

The term “article” and the like used within this application refers to technical research, papers, thesis data, reports, and the like written by one or more authors. The term “author” used herein may refer to a single author, or a group of multiple different authors. The term “technical” with reference to the various articles is intended to include various fields, including but not limited to scientific, technical, and medical fields. Specific examples include but are not limited to engineering, chemistry, biology, physics, mathematics, astronomy, planetary science, earth and environmental science, computer science, medicine, biology, social sciences, and humanities.

A reviewer 12b is a person technically qualified within the subject matter of the article and able to evaluate the article in a variety of different categories. Each reviewer 12b is initially evaluated to ensure his or her experience and abilities will provide an effective and accurate evaluation of the article. Reviewers 12b may meet the necessary requirements through his or her educational and/or business experiences. Examples of necessary requirements may include an advanced degree (e.g., Masters of Science and PhD degrees), employment in a particular technical field for a period of time, being a named author on one or more publications within a particular technical area, and combinations thereof.

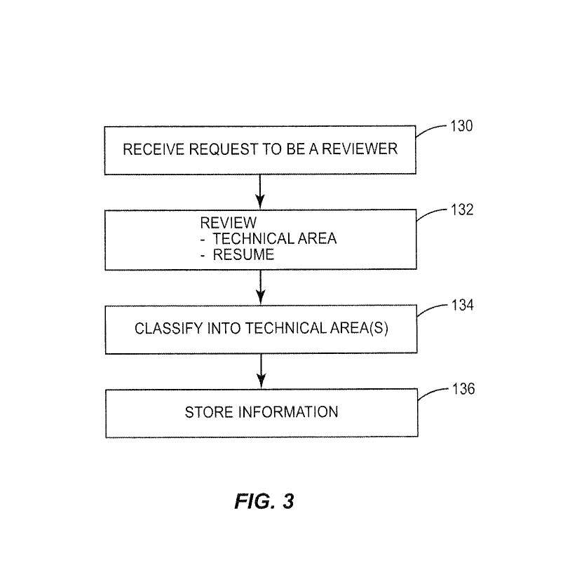

FIG. 3 illustrates one embodiment for qualifying a reviewer 12b within one or more technical fields. Initially, a request is received from a person that desires to be a reviewer (step 130). The request may include a resume or description of the person's technical qualifications (step 132). In one embodiment, the reviewer applicant completes a form accessible through the server website that includes a listing of the applicable technical fields.

The technical fields may be classified into various classes and subclasses to differentiate the subject matter in which the applicant has technical capabilities (step 134). By way of example, a reviewer applicant may indicate an expertise in electrical engineering. The applicant may also indicate a more specific expertise, such as antenna theory, wireless communications, and circuit analysis.

The applicant reviewer's information may be evaluated by a server administrator 12d who then inputs information to the server 10 indicating the one or more technical fields in which the reviewer applicant meets the necessary requirements to participate in the system. Alternatively, the server 10 may include a processing algorithm that uses the inputs entered by the reviewer applicant in the application form and calculates the one or more technical fields in which the reviewer applicant is qualified. The identification of the reviewer 12b and the corresponding one or more technical fields are stored at the server 10 (step 136). The reviewer 12b may be provided with an account to access the information on the server. The reviewer 12b is provided within login information to access the account, and may request that the user provide one or more usernames, passwords, etc. to provide security.

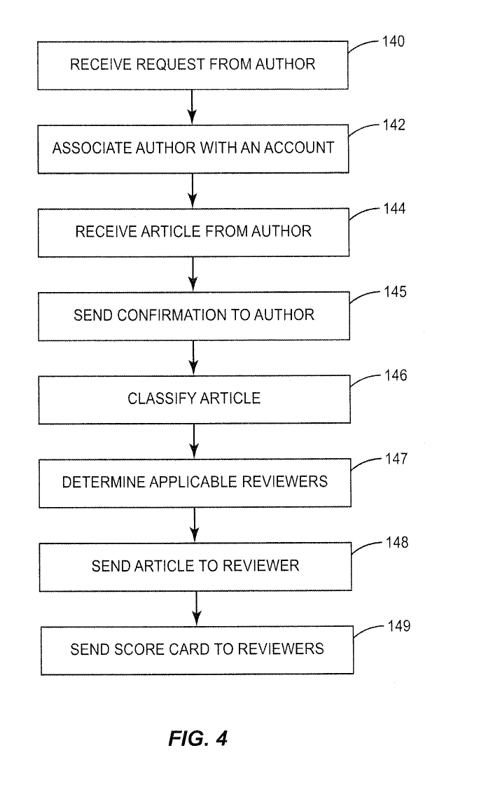

FIG. 4 illustrates one embodiment of the process for receiving the articles at the server 10. The process begins when the author 12a accesses the website and the server 10 and receives a request to submit an article (step 140). As part of the submission process, the author 12a may be required to establish an account (step 142). This may require the author to provide personal information such as name, home address, and email address. The subscription process may also require the author 12a to provide payment information for the service.

Once an account is initiated, the author 12a may be provided with login information to access the server 10 and his or her account. The login information may include one or more usernames, passwords, etc. to ensure that the account is safe from any mischievous activities by third parties. The account also allows the author 12a to upload his or her article to the server 10 (step 144). After receipt, the submitted article is stored on the server 10 and associated with the author's account. A confirmation may be sent to the author 12a indicating that the article was successfully uploaded (step 145). The confirmation may further provide an expected timeline for when the article will be reviewed, and when a final score is expected to be available.

The article is then classified into one or more technical categories (step 146). In one embodiment, the classification may be determined by the author 12a at the time the article is submitted to the server 10. This may include the author 12a selecting one or more technical categories that are provided at the time the article is uploaded to the server 10. Another manner of classifying the article is through an algorithm maintained at the server 10. The server 10 parses the entirety or one or more portions of the article for keywords indicating the one or more classifications. Still another manner is through input received from a server administrator 12d or reviewer 12b who reviews an entirety or portion of the article and provides the applicable classification(s).

The server 10 then determines the appropriate reviewers 12b to evaluate the article (step 147). This determination is based on the technical classification of the article and the technical classification of the reviewers 12b. The number of reviewers 12b may vary, with preferably at least two reviewers 12b being assigned to evaluate each article. In one specific embodiment, three reviewers 12b evaluate the article.

The article is then sent to each of the reviewers 12b (step 148), along with a scorecard 70 for evaluating the article (step 149). In one embodiment, this information is stored at the server 10 in the reviewer's accounts. The reviewers 12b can log onto his or her accounts and access this information. Alternatively, the article and scorecard 70 can be electronically delivered to the reviewers 12b.

Each reviewer 12b evaluates the article based on various predetermined requirements. In general, the article evaluation is based on an expected impact and technical competency. The expected impact judges the expected interest the article will generate within the particular technical field. This may include a number of different components, including the novelty of the article and whether other similar articles and/or information are available on the topic. Another component may include the interest in the topic by others in the particular technical field. The technical competency evaluates the quality of the research and the quality of the presentation of the information.

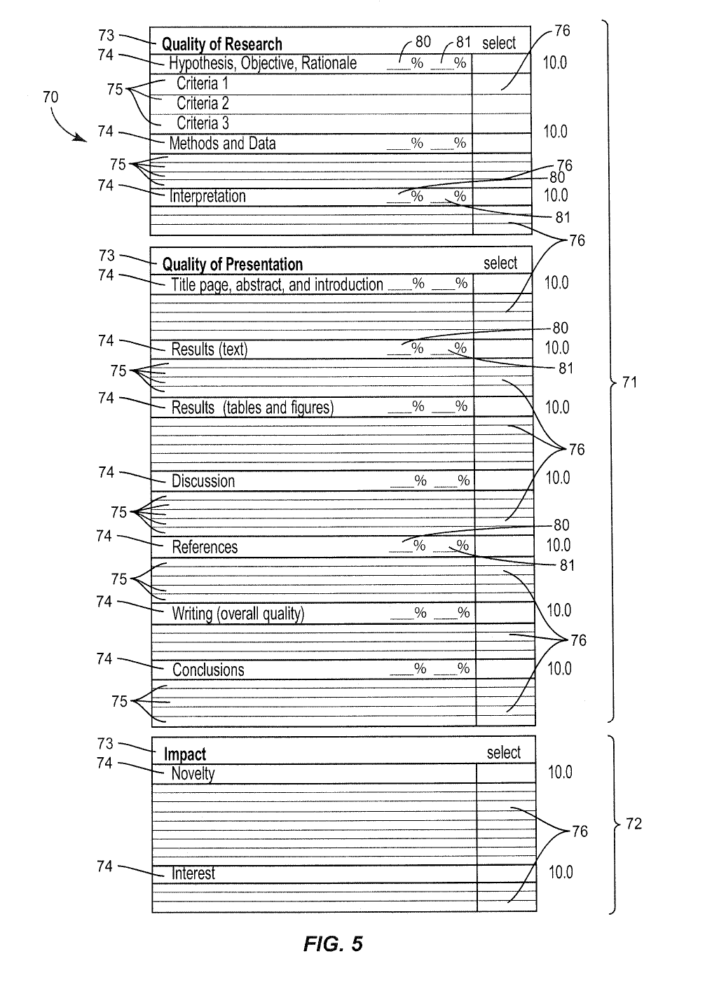

FIG. 5 illustrates a scorecard 70 that is sent to each reviewer 12b to evaluate the article. In general, the scorecard 70 is divided into a section 71 that evaluates the technical competency and a section 72 that evaluates the expected impact. Each of the sections 71, 72 includes one or more main evaluation components 73, and one or more detailed sub-components 74. The sub-components 74 include specific criteria 75 that are to be evaluated by the reviewers 12b. Examples of criteria 75 include positive aspects such as information is clearly presented, analysis supported by data, and clear writing. Negative examples include missing indicators, missing data, missing results, and biased commentary. The specific criteria 75 may require the reviewers 12b to input a numerical score (e.g., 0-10), a grade (e.g., A-F), a yes or no, a scaling grade (e.g., high, medium, low, N/A), or a combination thereof. Multiple scores may be input for one or more of the specific criteria 75 as the reviewer 12b deems to be applicable. For example, the “Interpretation” sub-component 74 provides for the reviewer 12b to input between one and four of the listed specific criteria 75 (e.g., meets the criteria, does not adhere closely to the data, biased or overstated interpretation, and leads to inaccurate conclusions). A position 76 is included for each of the sub-components 74 indicating a score for the particular sub-component 74.

In the embodiment of FIG. 5, the scorecard 70 includes three main evaluation components 73: quality of research; quality of presentation; and impact. Each of the components 73 may then include one or more sub-components 74. Each sub-component further includes one or more criteria 75.

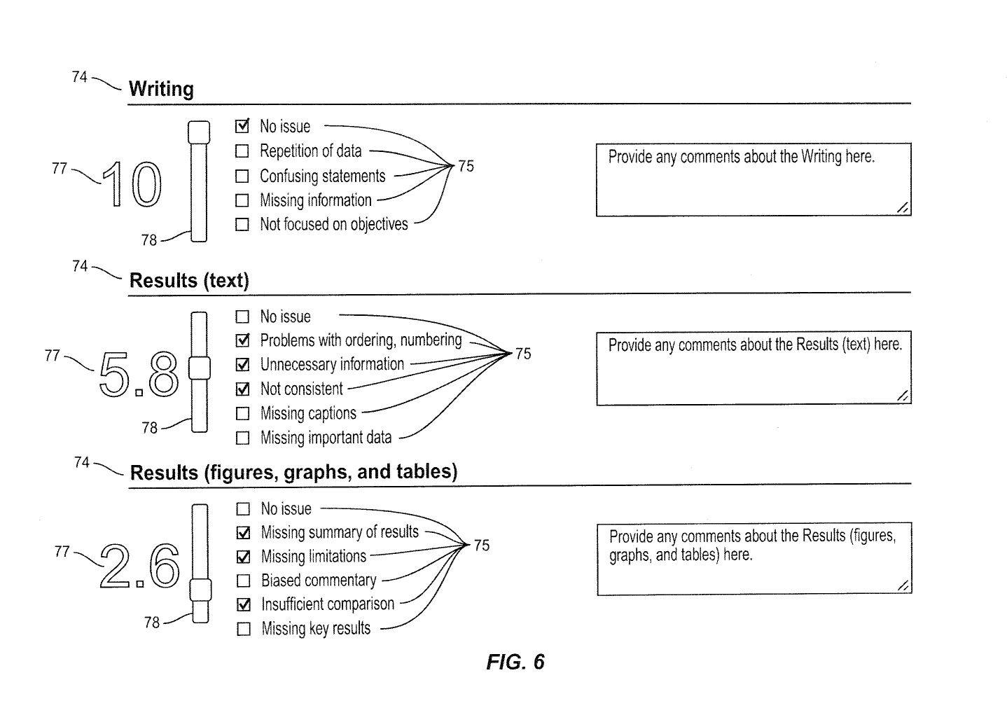

As the reviewer 12b inputs the relevant criteria 75, the scorecard 70 is configured to convert the inputs into a specific score. A criteria 75 that indicates a positive attribute results in a higher score, while a criteria 75 that indicates a negative attribute results in a lower score. FIG. 6 illustrates this concept and includes a limited section of a scorecard 70. When the reviewer 12b inputs the applicable criteria 75 within a sub-component 74, the scorecard 70 is configured to display a corresponding score 77. The assessment for each sub-component is calculated on a 0-10 scale. As the reviewer selects missing criteria 75, a weighted deduction from the 10-point scale is incorporated for a negative attribute and a weighted increase is incorporated for a positive attribute. Once the reviewer 12b has selected all of the missing criteria 75, a recommended score corresponding to the input from the reviewer 12 is displayed on the scorecard 70. A slider 78 is also displayed and positioned at the recommended score for the sub-component 74. The reviewer 12b can then adjust the score on the 0-10 scale if the recommendation does not match the reviewer's assessment of the article related to that sub-component 74. By way of example, the reviewer 12b may use a pointer associated with his or her device 13 and move the slider upward to increase the score. Likewise, the pointer may be used to move the slider downward to decrease the score.

The reviewer 12b may be instructed that each sub-component 74 may receive a maximum score (e.g., a score of 10). The slider 78 provides for the reviewer 12b to raise or lower the corresponding score 77 without changing any of the selections of the criteria 75. This provides for the reviewer 12b to adjust the score as they determine to be different than the allocated amounts based on the one or more selected criteria 75. Further, the scorecard 70 may provide for the reviewer 12b to add any commentary regarding one or more of the components 73 or sub-components 74.

The score for each sub-component 74 is provided to the reviewer 12b during the evaluation process as illustrated in FIG. 6. However, the reviewer 12b is not provided with an aggregate score for a component 73, or section 71, 72. This ensures the reviewer 12b provides his or her input on the specific criteria of the article, but is not involved in the determination of the aggregate score.

Once the reviewer 12b has completed his or her evaluation and the scorecard 70 is finalized, the reviewer 12b inputs the scorecard 70 to the server 10.

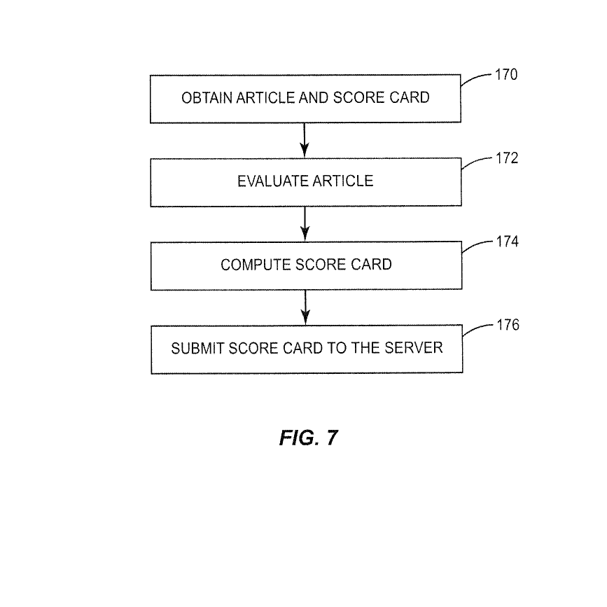

FIG. 7 includes a synopsis of the steps performed by the reviewer 12b during the evaluation of the article. Initially, the reviewer 12b accesses the article and the scorecard (step 170). The reviewer 12b then evaluates the article (step 172) and completes the scorecard 70 (step 174). Once complete, the reviewer 12b inputs the scorecard 70 to the server 10 (step 176).

The server 10 receives the scoring inputs from each of the reviewers 12b. The server 10 computes the various inputs using one or more algorithms to determine an aggregate score for the article. The server 10 may also compute and aggregate score for the components 73 and the sub-components 74. In one embodiment, an algorithm for determining an aggregate score includes computing an aggregate technical competency score and an aggregate expected impact score. The aggregate score for the article is calculated by factoring a percentage based on the aggregate expected impact score to the aggregate technical competency score.

As illustrated in FIG. 5, the scorecard 70 applies a weighting factor to each of the scores input by the reviewers 12b. For each component 73 within section 71, the sub-components 74 are allotted a first percentage 80 and a second percentage 81. The first percentage 80 is the weight given to the particular sub-component 74 when calculating an aggregate technical competency score (i.e., a score for section 71). The second percentage 81 is the weight given to the sub-component 74 when calculating an aggregate score for the corresponding component 73. The second percentage 81 is used to determine a quality of research score and a quality of presentation score for the article. For example, the “Methods and Data” sub-component 74 accounts for 30% of the aggregate technical competency score, and 55.6% of the score for the Quality of Research component 73. Likewise, “Discussion” is allocated a weight of 8% for the aggregate technical competency score and allocated a weight of 17.4% for the Quality of Presentation component 73.

Upon receiving the scoring inputs from each of the reviewers 12b, the server 10 calculates an aggregate technical competency score for the article. This calculation may include averaging the scores for each of the reviewers 12b. This score may further include a break-out that includes aggregate scores for the Quality of Research component 73 and the Quality of Presentation component 73. Further, the scoring may include a break-out for the specific sub-components 74.

In another embodiment, a greater weight may be given to the scores of one or more of reviewers 12b when determining the aggregate technical competency score and the sub-component scores. The input from these reviewers 12b is given more weight than the input of others because of some particularly reason, such as but not limited to more experience in reviewing articles and more academic or industry experience.

In one embodiment, the scores from each of the reviewers 12b are calculated for each of the sub-components 74. The server 10 then applies the various weighting factors 80, 81 to determine the aggregate score for the section 71 and the scores for the components 73 and sub-components 74.

The aggregate score for the expected impact section 72 includes a novelty component 73 that is divided into a novelty sub-component 74 and an interest sub-component 74. The novelty sub-component 74 is based on the scores for three separate criteria 75 including a new technique, a new question, and a new result. These criteria 75 are scored by each reviewer 12b as either high (H), medium (M), low (L), neutral (NA), or zero (0). A neutral score indicates the reviewer 12b did not find the article to be especially notable in terms of novelty.

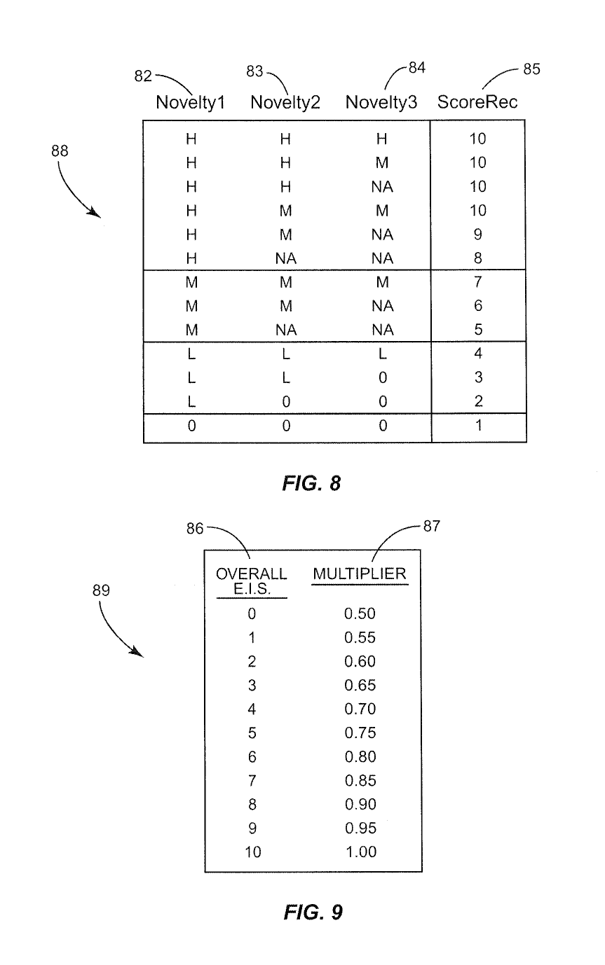

The server 10 initially calculates a score for the novelty sub-component 74 for each reviewer 12b using a look-up table 88 as illustrated in FIG. 8. The look-up table 88 equates the input scores (i.e., H, M, L, NA, 0) into a numerical number. The first column 82 (novelty 1) in the table 88 corresponds to the first criteria 75 (i.e., new technique). The second column 83 (novelty 2) corresponds to the second criteria 75 (i.e., new question). The third column 84 (novelty 3) corresponds to the third criteria 75 (i.e., new result). The table provides for a manner of equating the various scores into a numeric value listed in the fourth column 85. By way of example, a score of 10 is given to an article with three high (H) scores, a score of 7 is given to an article with three medium (M) scores, and a score of 2 is given to an article with one low (L) score and two zero (0) scores. In this embodiment, a score of 10 is the highest and a score of 1 is the lowest.

The interest sub-component 74 is determined based on the inputs relating to the various criteria 75. The scoring may be similar to that described above for the different technical competency sub-components 74.

Once numerical scores are calculated for the sub-components 74, the server 10 then calculates an aggregate expected impact score. This aggregate score is based on a calculation using the various novelty and interest sub-component scores from the various reviewers 12b. In one embodiment, the aggregate expected impact score is an average of these scores from the reviewers 12b. In another embodiment, greater weight is given to one or more of the reviewers 12b based on experience or some other determined criteria as described above.

The server 10 then determines an aggregate score for the article using the scores for the technical competency and expected interest. The server 10 may include another look-up table 89 as illustrated in FIG. 9 This table 89 provides a multiplier that corresponds to the numeric value of the aggregate expected impact score. The table 89 includes a first column 86 that lists the aggregate expected impact score that is calculated by the server 10 as described above, and a second column 87 for a corresponding multiplier. For example, an aggregate expected impact score of 1 has a multiplier of 0.55, and an aggregate expected impact score of 7 has a multiplier of 0.85.

The table 89 includes aggregate expected impacted scores having increments of one. Other embodiments may include smaller or larger increments as necessary.

The server 10 calculates an aggregate score for the article by applying the multiplier to the aggregate technical competency score. By way of example, an article with a technical competency score of 7.5 and a multiplier of 0.90 has an aggregate score of 6.75. Likewise, an article with a technical competency score of 8.0 and a multiplier of 0.65 has an aggregate score of 5.2.

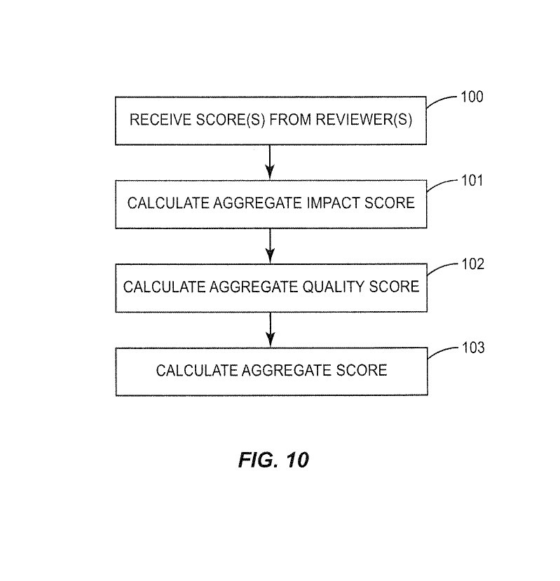

FIG. 10 illustrates the steps performed by the server 10 in calculating the aggregate score. The server 10 receives the completed scorecards 70 from the reviewers 12b (step 100). The server 10 calculates an aggregate score for the expected impact (step 101) and the technical competency (step 102). Finally, the server 10 calculates an aggregate score for the article (step 103).

The server 10 may further prepare an evaluation report for the article. This report may include the aggregate score for the article, an aggregate score for the expected impact, and an aggregate score for the technical competency. These scores may also be broken into the various components 73, such as quality of research score and quality of presentation score. The report may also include an aggregate score for one or more of the sub-components 74. Further, the report may include any comments provided by the reviewers 12b relative to any of the components 73, sub-components 74, or aggregate comments.

The report is sent to the author 12a. This may include associating the report with the author's 12a account to allow the author to access the report. This may also include sending the report to the author 12a in formats outlined in his or her account information, such as via electronic mail or postal mail.

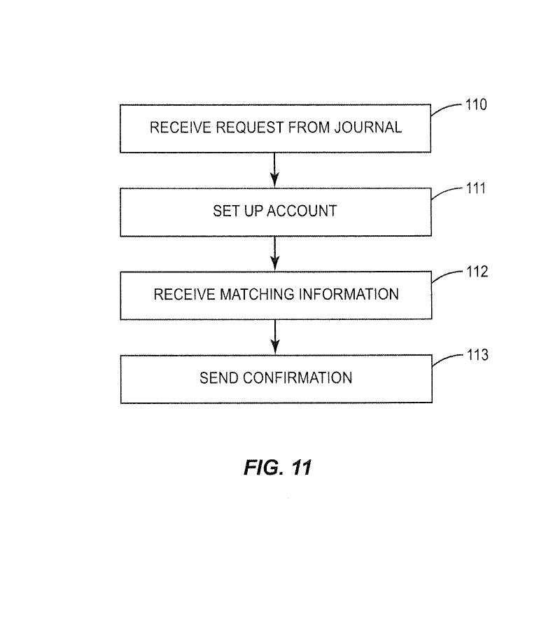

The system is further configured to match the articles with one or more technical journals. In one embodiment, the technical journals subscribe to the service by opening an account. FIG. 11 illustrates one embodiment for establishing an account at the server 10 from a technical journal (step 110). As part of the set-up process, the journal administrator may input relevant information to the server 10, such as name of the journal, address, and names of one or more journal administrators 12c (step 111). The set-up process may further require payment to establish the service. In another embodiment, the service is provided free to journals as a manner of attracting authors 12a to submit his or her articles.

Once an account is initiated, the journal administrator 12c may be provided with login information to access the server 10 and the account. The login information may include one or more usernames, passwords, etc.

The set-up process may also include receiving information that is of interest to the journal, including classification information on (step 112). The classification information may include keywords, technical categories, and Journal Citation Reports classification. The information may also include specific requirements that must be met by the article, such as a minimum aggregate score, minimum expected impact score, and minimum technical competency score. This information is stored on the server 10 and associated with the journal's account. A confirmation may be sent to the journal administrator 12c indicating that the account has been established (step 114). The confirmation may also include the term of the account, such as a 6-month or 1-year period in which the account will be active.

The journals may have access to the articles in different manners. The journals may be able to access the server 10 and to review each of the journals associated at the server 10. The server 10 may include searching ability to allow a journal administrator 12c to search for particularly relevant articles meeting one or more of the search terms.

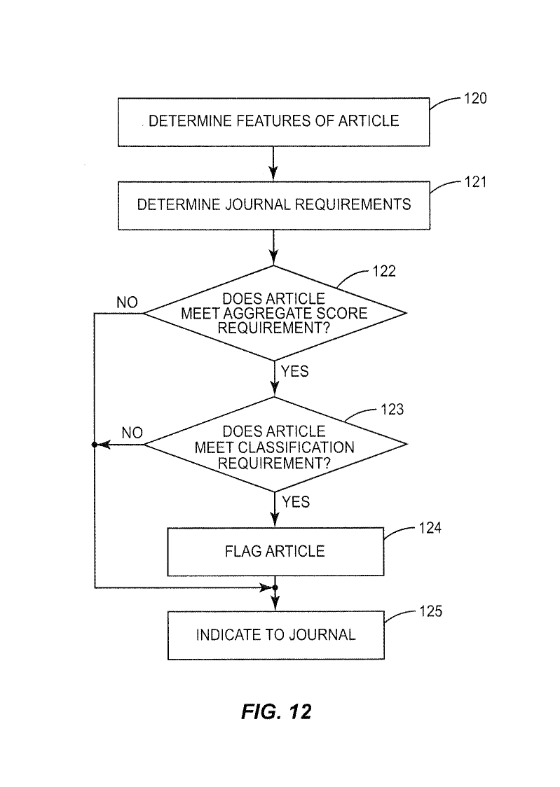

Another manner of providing articles to the journals is illustrated in FIG. 12. The server 10 determines the features of each of the articles (step 120). The features may include the aggregate score, classification, etc. The server 10 also determines the features of the particular journal (step 121). The server 10 then determines whether the article meets the aggregate score requirement from the journal (step 122). If the article meets this requirement, the server 10 then determines whether the article meets the classification requirement (step 123). If the article meets both requirements, the article is flagged (step 124). Flagging may include various aspects that highlight the article or otherwise bring the article to the attention of the journal that it meets the relevant criteria. Examples include but are not limited to sending the article to a specific journal administrator 12c, sending the article at the front of a larger number of articles, or checking a specific indicator on the article to indicate the relevance. If the article does not meet either of the requirements, the article is not flagged. Finally, the server 10 indicates the existence of the articles to the journal (step 125).

In some embodiments, articles are sent to journals at the time an aggregate score is calculated for the article. Other embodiments may include the articles being sent on a periodic basis.

The authors may also be provided with information regarding the journals. This may include a listing of all journals interested in receiving articles, or may include a subset of the journals. The server 10 may filter out journals that are not applicable, such as those requesting articles in different classifications not relevant to the author's article, or requesting articles having a minimum aggregate score that is higher than the author's article.

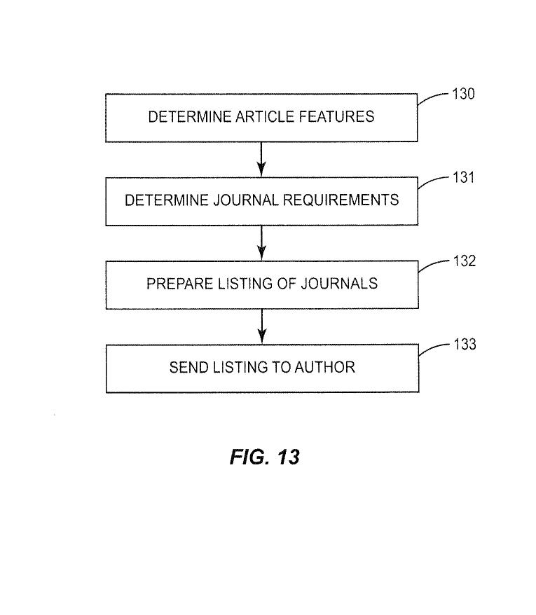

FIG. 13 illustrates the steps of one embodiment of a filtering process set up for a journal. Initially, the server 10 determines the features of the article (step 130) and the journal requirements (step 131). The server 10 compares the features and requirements and determines the journals for which the article meets or exceeds the desired requirements (step 132). The server 10 prepares a listing of these pertinent journals (step 133) and provides this listing to the author.

FIG. 1 includes one embodiment of a data communication network that is applicable to the functionality disclosed in the present application. It should be appreciated, however, that the present invention is not limited to any specific type of data communications network or access technology, as a variety of other structures may also be employed for various communications between the various entities. The network 8 may also include a mobile communication network for communicating with mobile devices, such as mobile phones, personal digital assistants, and the like. This network may operate according to any conventional standard, such as GSM, WCDMA, WiFi, WiMAX, and LTE standards.

In another embodiment, one or more of the aspects of the system and method may be performed outside of a networked configuration using physical delivery methods such as a postal mail system (e.g., U.S. Post Office, Federal Express) or hand-delivery. For example, the author 12a may submit the article in a hard-copy format that is physically delivered in some manner to the server administrator 12d. Likewise, the article and/or scorecard 70 can be physically delivered to one or more of the reviewers 12b, and one or more of the reviewers 12b may physically deliver his or her scores to the server administrator 12d. The server administrator 12d may further deliver the applicable information to one or more of the journal administrators 12c through a similar physical deliver manner. The above systems and methods are described within the context of evaluating and matching technical articles. The systems and methods may also be applicable to written articles relevant to other fields. These fields may include but are not limited to entertainment, sports, business, education, politics, history, and law. When used in these other fields, the corresponding journals are those that feature articles from the related fields.

As used herein, the terms “having”, “containing”, “including”, “comprising” and the like are open ended terms that indicate the presence of stated elements or features, but do not preclude additional elements or features. The articles “a”, “an” and “the” are intended to include the plural as well as the singular, unless the context clearly indicates otherwise. Further, terms such as “first”, “second”, and the like, are used to describe various elements, regions, sections, etc. are not intended to be limiting. Also, like terms refer to like elements throughout the description.

The present invention may be carried out in other specific ways than those herein set forth without departing from the scope and essential characteristics of the invention. The present embodiments are, therefore, to be considered in all respects as illustrative and not restrictive, and all changes coming within the meaning and equivalency range of the appended claims are intended to be embraced therein.

1. A method of evaluating a technical article having an assigned technical field, the method being implemented by an evaluation server configured to communicate with computing devices via a packet data network and comprising:
determining a plurality of reviewers for a technical article based on a technical classification of the article and a technical classification of the plurality of reviewers;
transmitting via the packet data network to the respective computing devices of the plurality of reviewers the technical article and an electronic evaluation interface including a first set of predefined grading criteria for determining an expected impact of the article within the technical field which is an expected interest the article will generate with a particular technical field, and a separate second set of predefined grading criteria for determining a technical competency of the technical article which is a quality of research and presentation of information;
receiving from the respective computing devices of the reviewers via the packet data network, selected ones of the predefined grading criteria;
calculating an aggregate expected impact score for the article based on the received criteria selections for the first set of grading criteria from each of the plurality of reviewers;
obtaining through a predefined mapping function, a multiplier based on the aggregate expected impact score;
calculating an aggregate technical competency score based on the received criteria selections for the second set of grading criteria from each of the plurality of reviewers;
calculating an aggregate score for the article as a function of the aggregate technical competency score and the multiplier, the aggregate score being independent of the technical field;
generating an electronic report for the article that includes at least the aggregate score for the article; and
transmitting the electronic report via the packet data network to an author of the technical article.

2. The method of claim 1, wherein calculating the aggregate expected impact score based on the received criteria selections for the first set of grading criteria from each of the plurality of reviewers comprises determining a numerical value for each of the criteria selections from each of the reviewers and averaging the numerical values.

3. The method of claim 1, wherein calculating the aggregate technical competency score based on the received criteria selections for the second set of grading criteria from each of the plurality of reviewers comprises determining a numerical value for each of the received criteria selections from each of the reviewers and averaging the numerical values.

4. The method of claim 1, further comprising accessing a look-up table maintained at the evaluation server and determining the multiplier based on the aggregate expected impact score.

5. The method of claim 4, wherein the multiplier is a numerical number between 0.50 and 1.0.

6. The method of claim 1, further comprising calculating an aggregate quality of research score and an aggregate quality of presentation score based on the received criteria selections for the second set of grading criteria from each of the reviewers.

7. The method of claim 1, further comprising transmitting the report via the packet data network to a journal that publishes information within the technical field.

8. The method of claim 1, further comprising dynamically providing, through the evaluation interface, visual indicators to the reviewers corresponding to the received criteria selections.

9. The method of claim 1, wherein the multiplier is less than or equal to one.

10. A method of evaluating a technical article, the method being implemented by an evaluation server configured to communicate with computing devices via a packet data network, the method comprising:
transmitting via the packet data network to the respective computing devices of a plurality of reviewers a technical article that is applicable to a particular technical field and an electronic evaluation interface for evaluating the technical article, the reviewers being selected based on their technical backgrounds relative to a technical field of the article, the electronic evaluation interface including:
a plurality of predefined evaluation components, each of the evaluation components further including one or more sub-components;
one or more predefined grading criteria for each of the one or more sub-components;
for each reviewer, receiving through the electronic evaluation server and via the packet data network, which ones of the predefined grading criteria were selected by the reviewer;
for each reviewer, dynamically providing through the packet data network and displaying on the electronic evaluation interface visual indicators indicating a score for each of the sub-components, the scores corresponding to the received criteria selections;
for each reviewer, receiving through the electronic evaluation server and via the packet data network an input for adjusting at least one of the sub-component scores without changing the grading criteria selected by the reviewer;
calculating a reviewer score for each reviewer based on the grading criteria selected by the reviewer and the input for adjusting at least one of the sub-component scores;
calculating an aggregate score for each of the evaluation components based on the corresponding scores from each of the reviewers;
calculating an aggregate score for the technical article based on the aggregate scores for each of the evaluation components;
generating an electronic report for the technical article that includes at least the aggregate score for the technical article; and
transmitting the electronic report via the packet data network to an author of the technical article.

11. The method of claim 10, wherein the plurality of evaluation components includes a technical competency component and an expected impact component.

12. The method of claim 10, further comprising calculating at least one sub-component score for each of the reviewers by accessing a look-up table.

13. The method of claim 10, further comprising sending the electronic report via the packet data network to a journal that publishes information within the technical field.

14. The method of claim 10, wherein calculating the aggregate score for each of the evaluation components based on the corresponding scores from each of the reviewers includes averaging the corresponding scores.

15. The method of claim 10, wherein calculating an aggregate score for each of the evaluation components based on the corresponding scores from each of the reviewers includes weighting the corresponding score from at least one of the reviewers a greater amount than another one of the reviewers.

16. A method of matching technical articles to prospective journals, the method being implemented by a server configured to communicate with computing devices via a packet data network and comprising:
receiving a request through a first electronic request interface via the packet data network from each of a plurality of journals that each publish information within one or more technical areas, the requests each including requirements for a desired technical field and a minimum aggregate score;
receiving a plurality of technical articles from computing devices of authors through a second electronic evaluation interface via the packet data network, each of the technical articles being classified in a particular technical field;
storing each of the technical articles;
evaluating each of the articles using at least two independent reviewers selected based on their technical backgrounds and calculating an aggregate score for the article, the aggregate score being determined through a first set of predefined grading criteria for determining an expected impact of the article within the technical field which is an expected interest the article will generate with a particular technical field, and a separate second set of predefined grading criteria for determining a technical competency of the technical article which is a quality of research and presentation of information;
generating an electronic report for each of the articles that includes at least the aggregate score;
mapping each of the articles with the corresponding aggregate score and the technical field;
indicating to each of the journals, through the first electronic request interface via the packet data network, the evaluated articles and flagging the articles with the aggregate score meeting the minimum aggregate score and being classified in the desired technical field; and
transmitting to each of the authors, through the second electronic evaluation interface via the packet data network, a listing of the journals in which their article satisfies the journal requirements.
